(19) United States
(12) Patent Application Publication
(10) Pub. No.: US 2019/0377893 A1
(43) Pub. Date: Dec. 12, 2019

(54) SYSTEMS AND METHODS FOR DETECTING, TRACKING, AND ANALYZING ACCESS TO DIGITAL INFORMATION

(71) Applicant: Nisos Group, LLC, Alexandria, VA (US)

(72) Inventors: Vincas D. CIZIUNAS, Leesburg, VA (US); Robert Joseph RAINES, Powder Springs, GA (US); Zachary Allen HENSON, Brooklyn, NY (US)

(73) Assignee: Nisos Group, LLC, Alexandria, VA (US)

(21) Appl. No.: 16/438,825

(22) Filed: Jun. 12, 2019

Related U.S. Application Data
(60) Provisional application No. 62/683,756, filed on Jun. 12, 2018.

(51) Int. Cl. G06F 21/62; H04L 29/06

(52) U.S. Cl. CPC G06F 21/6218; H04L 63/0272; H04L 63/1491

(57) ABSTRACT

A method for detecting and tracking access to digital information to identify and limit data loss includes defining, at a host device, an access policy associated with accessing files on a network. The host device automatically receives a signal in response to a triggering event associated with a file being acted on by an electronic device. The signal includes data associated with (1) a request for a resource stored at a predetermined location within the network, (2) the file, and (3) the electronic device. The data associated with the resource request, the file, and the electronic device is stored in a database. The host device analyzes the data stored in the database to define an analyzed data set associated with the triggering event. The host device defines an alert in response to one or more characteristics of the analyzed data set being noncompliant with the access policy.

### CROSS-REFERENCE TO RELATED APPLICATIONS

This application claims priority to and the benefit of U.S. Provisional Patent Application Ser. No. 62/683,756 entitled, “Systems and Method for Detecting, Tracking, and Analyzing Access to Digital Information,” filed Jun. 12, 2018, the disclosure of which is incorporated herein by reference in its entirety.

### FIELD

Described are systems and methods for data loss detection and/or protection, and more particularly, systems and methods for detecting, tracking, and/or analyzing access to digital information, for example, based on data associated with one or more tags embedded in digital files.

### BACKGROUND

Modern increases in the capabilities of electronic devices have led to significant increases in digital information that is stored within those devices. In some instances, the subject matter of the stored information (data) can be publically available or publically accessible information. In other instances, however, the subject matter of the data can be highly confidential, proprietary, and/or secret. The need to maintain the confidentiality of such information has led to various modes of protecting the data against unauthorized access. Many such protection modes and/or methods attempt to detect motion of data in transit and do not fully account for surreptitious methods used by attackers to encrypt or obfuscate their spoils in transit.

Data Loss Prevention (DLP) technology is intended to detect and prevent exfiltration of data while the data is in use, in motion, and at rest. In general, perimeter defense to data loss may help prevent undesired or unauthorized access of the internal network (e.g., a firewall or the like). Such methods, however, do not prevent access by a skilled attacker. Moreover, once a file has been taken outside of the perimeter of such DLP systems, there is little way to track its movement.

As such, a need exists for improved systems and methods for detecting, tracking, and analyzing unauthorized access to digital information.

### SUMMARY

Systems and methods for detecting, tracking, and analyzing access to digital information are described herein. In some embodiments, a method for detecting and tracking access to digital information to identify and limit data loss includes defining, at a host device, an access policy associated with accessing files on a network. The host device may automatically receive a signal in response to a triggering event associated with a file being acted on by an electronic device. In some variations, the signal includes data associated with (1) a request for a resource stored at a predetermined location within the network, (2) the file, and (3) the electronic device. The data associated with the resource request, the file, and the electronic device is stored in a database. The host device analyzes the data stored in the database to define an analyzed data set associated with the triggering event. In some instances, the host device defines an alert in response to one or more characteristics of the analyzed data set being noncompliant with the access policy.

### BRIEF DESCRIPTION OF THE DRAWINGS

FIG. 1 is a schematic illustration of a system for detecting, tracking, and analyzing access to digital information according to an embodiment.

FIGS. 2-5 are schematic diagrams illustrating at least a portion of a system and/or a method of using the system to detect, track, and analyze access to digital information, each according to a different embodiment.

FIG. 6 is a flowchart illustrating a method of detecting, tracking, and analyzing access to digital information according to an embodiment.

FIG. 7 is a flowchart illustrating a method of detecting, tracking, and analyzing access to digital information according to an embodiment.

### DETAILED DESCRIPTION

Systems and methods for detecting, tracking, and analyzing access to digital information are described herein. Any of the embodiments, systems, and/or methods described herein may be implemented in one or more networks to detect, track, and/or analyze access to digital files having and/or otherwise associated with one or more digital tags. For example, the systems and/or methods described herein may be used to collect information about the creation, access, and/or modification of tagged files and/or applications. In addition, the systems and/or methods may collect information about the device(s) used to create, access, and/or modify the tagged files and/or applications. Based at least in part on the collected information, the systems and/or methods may be used to determine, for example, where files have been opened and/or where the applications have been accessed or used, if and/or when the control of the file was lost (e.g., removed from the network), who last saved a file prior to loss of control, when a file was last detected on the network prior to loss of control, where a file was stored on the network prior to loss of control, information associated with an unauthorized reader, patterns of loss, ways to prevent future loss, and/or the like.

In general, the systems and/or methods described herein include a beacon agent (either located on a user device or a host device) configured to embed a beacon or tag (e.g., by wrapping, insertion, and/or the like) into a digital file such that when a program that is commonly used to open or act on the file opens a beaconed file, the beacon or tag instructs the program to request a resource from the host device. The resource request results in data associated with the file, user, and/or the user's device to be sent to the host device or server. The data can then be analyzed (e.g., automatically via the host device or server or via human analysis). In some embodiments, the system can be configured to present an analysis and/or visualization platform that can provide the system's end-user (e.g., an administrator or analyst) with a dashboard that can present data associated with the beaconed file. For example, the dashboard can present the IP addresses from which the files were opened, a map of the geographic locations corresponding to those IP addresses, the frequency with which those files were opened, the operating system and the program software used to open the files, and/or the like. The analysis platform can determine and/or can help to determine when digital property was lost, patterns of loss, and the identity of the unauthorized reader, thief, attacker, or misappropriating data abuser.

In some embodiments, a method for detecting and tracking access to digital information to identify and limit data loss includes defining, at a host device, an access policy associated with accessing files on a network. The host device automatically receives a signal in response to a triggering event associated with a file being acted on by an electronic device. The signal includes data associated with (1) a request for a resource stored at a predetermined location within the network, (2) the file, and (3) the electronic device. The data associated with the resource request, the file, and the electronic device is stored in a database. The host device analyzes the data stored in the database to define an analyzed data set associated with the triggering event. In some instances, the host device defines an alert in response to one or more characteristics of the analyzed data set being noncompliant with the access policy.

In some embodiments, a method for detecting and tracking access to digital information to identify and limit data loss includes automatically receiving, at a host device, a signal in response to a triggering event associated with a file accessible via a network. The signal includes data associated with (1) a request for a resource stored at a predetermined location within the network, (2) the file, and (3) an electronic device acting on the file. The host device sends the requested resource to the electronic device such that the resource is embedded into the file. The host device stores the data associated with the resource request, the file, and the electronic device in a database configured to store data associated with a number of resource requests, a number of files that are accessible via the network, and a number of electronic devices having at least temporarily stored at least one file from the number of files. The data stored in the database associated with the resource requests, the files, and the electronic devices is analyzed to define an analyzed data set and a pattern of access of the files accessible via the network is defined.

In some embodiments, a system includes an electronic device in communication with a network, a beacon agent in communication with the network, and a host device in communication with the network. The electronic device may be configured to at least temporarily store a file accessible via the network. The beacon agent may be configured to collect data associated with the file and the electronic device in response to a triggering event and to send the collected data to the host device. The collected data may include, for example, (1) a request for a uniform resource identifier (URI) of a resource stored on the network and (2) the data associated with the file and the electronic device. The host device may be coupled to a database configured to store data associated with at least (1) a number of files accessible via the network and (2) a number of electronic devices having at least temporarily stored at least one file from the number of files. The host device may be configured to (1) store the data associated with the file and the electronic device in the database, (2) analyze the data stored in the database associated with the number of files and the number of electronic devices to define an analyzed data set, and (3) define a pattern of access of the number of files accessible via the network.

As used in this specification and the claims, the singular forms “a,” “an” and “the” include plural referents unless the context clearly dictates otherwise. Thus, for example, the term “a file” is intended to mean a single file or a combination of files, “a network” is intended to mean one or more networks, and “a beacon” is intended to mean a single beacon or a combination of beacons.

As used herein, the terms “beacon” and “tag” can be used interchangeably to refer to specific data inserted into, embedded into, and/or wrapped around a file. For example, in some embodiments, a beacon can be a uniform resource identifier (URI) and/or data associated with a URI that identifies, references, and/or locates a resource stored on a network. For example, a beacon can be a URI having a format, syntax, and/or scheme based on Request for Comments (RFC) 3986. Moreover, the beacon can provide instructions to perform a network request for the resource identified by the URI.

As described in further detail herein, the systems and/or methods may be used to insert beacons and/or tags into files that can be opened, read, modified, and/or saved by any suitable software program, application, and/or the like. For example, in some embodiments, the systems can be configured to insert beacons into documents including text, images, interactive design elements, etc. In some instances, a particular file type can allow for the insertion of a beacon (e.g., a “beacon-ready file type”). Examples of such beacon-ready file types can include but are not limited to XML based formats (e.g., an Office Open XML document compressed with the Zip standard of compression (DOCX, PPTX, XLSX, VSDX)), the Portable Document Format (PDF), the Open Document Format (ODF), multimedia container formats such as the Advanced Systems Format, source code project formats such as the Visual Studio Project File Format (VCXPROJ), binary formats such as the Microsoft Office 97 format (doc, ppt, xls, vsd), structured text formats such as a Makefile, computer aided design (CAD) formats, propriety formats, and/or the like.

In some instances, a beacon-ready file may be any suitable non-beacon-ready file that may be contained in, embedded into, and/or wrapped by a beacon-ready file. That is to say, in some instances, a beacon-ready file may be a container file or the like that is configured to contain, wrap, and/or otherwise include a non-beacon-ready file. As such, the beacon-ready file or container may contain and/or may be embedded with a beacon, which in turn, is associated with the non-beacon-ready file contained, wrapped, and/or otherwise included in the beacon-ready file or container. In some instances, the beacon-ready file (e.g., the container file) and the non-beacon-ready file may have the same file extension and/or may be opened by the same software and/or application.

Any suitable viewer, reader, and/or editor software compatible with a beacon-ready file type can be used to access, open, read, edit, modify, save, etc. a beaconed file. In some instances, such programs and/or applications may be configured to automatically read, load, and/or take action based on the URI indicated by the beacon inserted into beaconed files. For example, in some embodiments, such beacon-compatible programs and/or applications may include, run, and/or execute (e.g., as an add-in or plugin of the program and/or application) a “beacon agent.” In some instances, the beacon agent may be called (e.g., by the beacon compatible program) and/or executed (e.g., by hardware) to insert a beacon (e.g., URI) or a resource into a file and to receive, collect, and/or send information associated with the file (also referred to as the “beaconed file”) to one or more devices in communication with the network such as, for example, one or more host devices and/or servers. In some embodiments, a beacon agent can automatically read, insert, and/or otherwise act on or in accordance with a beacon in a beaconed file (e.g., a document or the like) without user intervention and the beacon or tag need not be known or visible to a user viewing the contents of the file.

While the systems and/or methods are described herein as being used to insert and/or embed beacons and/or tags into the files and to analyze data associated with the access, use, and/or modification of the beaconed or tagged files, in other embodiments, the systems and/or methods described herein may be used to insert and/or embed beacons and/or tags into software, applications, executables, and/or the like. For example, in some instances, a beacon-ready application may be embedded and/or tagged with a beacon such that when the application is accessed (e.g., either by a user of an electronic device on which the application is executed and/or programmatically or remotely via a script, a secure shell (SSH) session, and/or the like), the beacon or tag instructs the application to request a resource from a host device, server, etc. As described herein with reference to beaconed files, the resource request resulting from the execution of the application, in turn, results in data associated with the execution of the application to be sent to the host device, server, etc. Accordingly, the systems and/or methods described herein may be used to beacon individual files, containers, software, applications, executables, and/or the like and may collect data associated with the access and/or execution thereof.

While a beacon agent is described above as being a local program, application, add-in, plugin, and/or the like stored by and/or executed by a user device, in other embodiments, a beacon agent can be a system agent, application, program, and/or the like stored by and/or executed by a system device such as a host device, administrator device, server, and/or any other cloud-based agent. As such, a system-based beacon agent can interact with beacon-compatible file viewers, readers, and/or editors to read, insert, and/or otherwise act on or in accordance with a beacon in a beaconed file with or without user intervention and/or knowledge.

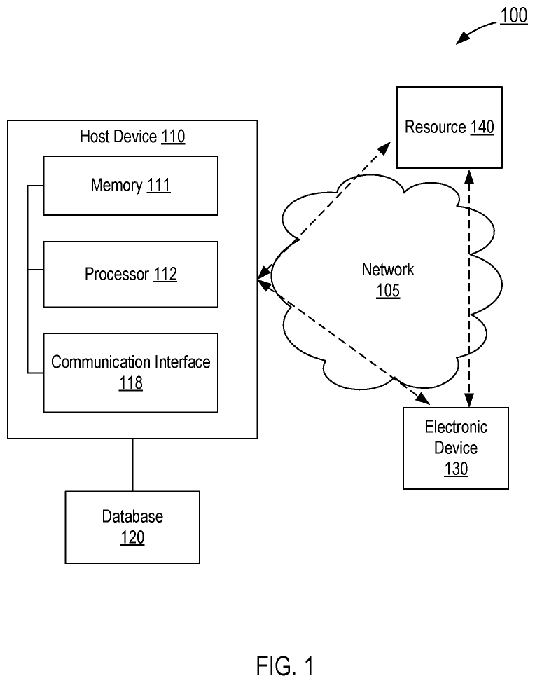

FIG. 1 is a schematic illustration of a system 100 for detecting, tracking, and analyzing access to digital information according to an embodiment. Generally, the system 100 may be implemented in one or more networks to detect, track, and/or analyze access to digital files having and/or otherwise associated with one or more digital beacons or tags. For example, a digital beacon or tag can be, for example, a URI of a resource (e.g., an image or other suitable resource) stored and/or saved on the network that is embedded into a file. The digital beacon, tag, or URI may then be configured to instruct an electronic device or a software application run either on the electronic device or on a host device within the network to initiate a download of the resource in response to a triggering event such as the creation of a file, opening a saved file, editing or modifying a file, saving a file, and/or the like. The transmission or sending of a request(s) to download the resource and/or the transmission or sending of the resource itself, in turn, allows the system 100 to determine information associated with the file, the triggering event, and the electronic device on which the file is being created, accessed, saved, etc.

The system 100 may, for example, analyze this data to determine, for example, information associated with the electronic device or a user thereof; an estimated time in which a beaconed file was removed from an authorized network or and authorized portion of a network (e.g., an estimated time of breach); a hostname of the electronic device on which the beaconed file existed during the estimated time of breach; an approximate geographic area of a user or device that accessed the beaconed file; one or more patterns associated with authorized or unauthorized access of beaconed files; and/or any other suitable information. Moreover, based on the analysis, the system 100 may determine and/or predict potential vulnerabilities of a network, system, and/or portion thereof; can determined and/or predict files of interest based on one or more patterns of access; can create “honeypot” files and/or the like having enhanced security or subject to enhanced monitoring; and/or can perform any other suitable process associated with detecting, tracking, and/or analyzing authorized or unauthorized access to digital information.

As shown in FIG. 1, in general, the system 100 includes a host device 110 in communication with at least one electronic device 130 via a network 105. The system 100 may be implemented in any suitable network environment. For example, in some embodiments, the system 100 can be an enterprise system and/or can be a portion of an enterprise network or the like (e.g., the network 105 forms at least a portion of an enterprise network). In other embodiments, the system can be a personal or home system and/or can be a portion of a personal or home network or the like (e.g., the network 105 forms at least a portion of a home network). The system 100 also includes a resource 140 stored and/or saved at a predetermined location in the network 105. For example, in some embodiments, the resource 140 can be stored and/or saved on or in the host device 110. In other embodiments, the resource 140 can be stored and/or saved on or in an electronic device that is separate and/or distinct from the host device 110 (e.g., a network attached storage (NAS) device, server, database, etc.). The electronic device 130 and/or the host device 110 can be configured to selectively access the resource 140 in response to a triggering event, as described in further detail herein.

The network 105 may be any type of network such as, for example, a local area network (LAN), a wireless local area network (WLAN), a virtual network such as a virtual local area network (VLAN), a wide area network (WAN), a metropolitan area network (MAN), a worldwide interoperability for microwave access network (WiMAX), a cellular network, the Internet, and/or any other suitable network or combination of networks implemented in a wired and/or wireless configuration. By way of example, the network 105 can be implemented, at least in part, as a LAN and/or WLAN. In some embodiments, the electronic device 130 may communicate with the host device 110 and the network 105 via intermediate networks and/or alternate networks (not shown), which can be similar to or different from the network 105. As such, the electronic device 130 may send data to and/or receive data from the host device 110 using multiple communication modes (e.g., associated with any of the networks described above) that may or may not be transmitted to the host device 110 using a common network.

The host device 110 may be any suitable electronic or compute device configured to send data to and/or receive data via the network 105 (e.g., sent to or from the electronic device 130). In some embodiments, the host device 110 can function as, for example, a server device, a network management device, an administrator device, a network attached storage (NAS) device, and/or so forth. In general, the host device 110 includes at least a memory 111, a processor 112, and a communication interface 118. As shown in FIG. 1, the memory 111, the processor 112, and the communication interface 118 may be connected and/or electrically coupled such that electric and/or electronic signals may be sent between the memory 111, the processor 112, and the communication interface 118. The host device 110 may also include and/or can otherwise be operably coupled to a database 120 configured, for example, to store data associated with files accessible via the network 105, as described in further detail herein.

The memory 111 of the host device 110 may be, for example, a random access memory (RAM), a memory buffer, a hard drive, a read-only memory (ROM), an erasable programmable read-only memory (EPROM), an electrically erasable programmable read-only memory, flash memory, and/or the like. In some instances, the memory 111 of the host device 110 includes a set of instructions or code (e.g., executed by the processor 112) used to perform one or more actions associated with communicating with the network 105 and/or one or more actions associated with authentication actions and/or used to detect, track, and analyze access to digital information accessible via the network 105, as described in further detail herein.

The processor 112 of the host device 110 may be any suitable processor such as, for example, a general-purpose processor (GPP), a central processing unit (CPU), an accelerated processing unit (APU), a network processor, a front end processor, a field programmable array (FPGA), an Application Specific Integrated Circuit (ASIC), and/or the like. The processor 112 can be configured to perform and/or execute a set of instructions, modules, and/or code stored in the memory 111. For example, the processor 112 may be configured to execute a set of instructions, code, and/or modules (e.g., stored in the memory 111) associated with, inter alia, communicating with the network 105 and/or one or more actions associated with authentication actions and/or used to detect, track, and analyze access to digital information accessible via the network 105, as described in further detail herein.

The communication interface 118 may be any suitable device that can place the host device 110 in communication with the electronic device 130 and/or the resource 140. In some embodiments, the communication interface 118 may include one or more wired and/or wireless interfaces (e.g., a network interface card), such as, for example, Ethernet interfaces, optical carrier (OC) interfaces, asynchronous transfer mode (ATM) interfaces, and/or wireless interfaces (e.g., a WiFi® radio, a Bluetooth® radio, a near field communication (NFC) radio, and/or the like). Thus, the host device 110 may receive data from and/or send data to the electronic device 130 (or any other suitable device in communication with the network 105) via the communication interface 118 and the communication interface (not shown in FIG. 1) of the electronic device 130 and/or a communication interface (not shown in FIG. 1) of the resource 140.

The database 120 associated with and/or coupled to the host device 110 can be any suitable database such as, for example, a relational database, an object database, an object-relational database, a hierarchical database, a network database, an entity-relationship database, a structured query language (SQL) database, an extensible markup language (XML) database, and/or the like. In some embodiments, the database 120 can be stored in the memory 111 of the host device 110. In other embodiments, the database 120 can be operably coupled to the host device 110 via a cable, a bus, a server rack, and/or the like. In some embodiments, the host device 110 can be in communication with the database 120 over any suitable network (e.g., the network 105) via the communication interface 118. In such embodiments, the database 120 can be included in or stored by a NAS device. In such embodiments, the NAS device and/or the database 120 can communicate with the host device 110 over the network 105 and/or any other network(s).

The database 120 may store and/or at least temporarily retain data associated with the system 100. For example, in some instances, the database 120 can store data associated with and/or otherwise representing files accessible via the network, user profiles, resource lists and/or URIs associated therewith, network and/or access policy(ies), authentication modes or methods, authorized devices, authorized users, authorized network locations, authorized geographic locations, known threats and/or vulnerabilities, whitelists, blacklists, etc. In some embodiments, the database 120 can be and/or can include a relational database, in which data can be stored, for example, in tables, matrices, vectors, etc. according to the relational model. By way of example, in some instances, the host device 110 can be configured to store in the database 120 data associated with files accessible via the network and one or more relationships between the files and data associated with accessing of the file, a URI or resource embedded in the file, triggering events, electronic devices having at least temporarily stored the file, and/or the like. In addition, the database 120 can store data associated with an analysis (e.g., performed by the host device 110) of at least a portion of the data stored in the database 120, as described in further detail herein.

Although the host device 110 is shown and described with reference to FIG. 1 as being a single device, in other embodiments, the host device 110 can be implemented as any suitable number of devices collectively configured to perform as the host device 110. For example, the host device 110 can include and/or can be collectively formed by any suitable number of server devices or the like. In other embodiments, the host device 110 can be a virtual machine, virtual private server, and/or the like that is executed and/or run as an instance or guest on a physical server or group of servers. In some such embodiments, the host device 110 can be stored, run, executed, and/or otherwise deployed in a cloud-computing environment. Such a virtual machine, virtual private server, and/or cloud-based implementation can be similar in at least form and/or function to a physical machine. Thus, the host device 110 may be implemented as one or more physical machine(s) or as a virtual machine run on a physical machine. In other words, the host device 110 may be configured to perform any of the processes, functions, and/or methods described herein whether implemented as a physical machine or a virtual machine.

While the host device 110 is described above as including and/or otherwise being operably coupled to the database 120 (i.e., a single database), in some embodiments, the host device 110 can be operably coupled to any number of databases. Such databases can be configured to store at least a portion of the data accessible and/or otherwise transmitted via the network. For example, in some embodiments, the host device 110 can be operably coupled to and/or otherwise in communication with a database that is stored in or on the electronic device 130. In this manner, the host device 110 and, in some instances, the database 120 can be in communication with any number of databases that can be physically disposed in a different location than the host device 110, while being in communication with the host device 110 (e.g., via the network 105).

The electronic device 130 may be any suitable electronic and/or compute device such as a server, PC, a laptop, a convertible laptop, a tablet, a personal digital assistant (PDA), a smart phone, and/or any other mobile electronic device, as described in further detail herein. Although not shown in FIG. 1, in some embodiments, the system 100 may include any number of electronic devices that are placed in communication with the network 105. Thus, the electronic device 130 can represent any suitable electronic device that communicate with the network 105 (e.g., either an authorized device or an unauthorized device) and is presented by way of example only and not limitation. For example, while the electronic device 130 is described as being, for example, a client device or user-facing device, in some instances, the electronic device 130 can be a server, a remote device accessing the network 105 via an SSH session or the like, a virtual machine, and/or any other suitable device. Accordingly, the electronic device 130 may be any suitable device configured to access the network 105 directly or indirectly (e.g., via a remote, virtual, and/or programmatic implementation).

Although not shown, the electronic device 130 can include at least a memory, a processor, a communication interface, and one or more user interfaces. The memory, the processor, the communication interface, and the user interface(s) can be connected and/or electrically coupled to each other such as to allow signals to be sent therebetween, as described above with reference to the host device 110. For example, in some embodiments, the memory of the electronic device 130 can be RAM, a memory buffer, a hard drive, ROM, EPROM, EEPROM, flash memory, and/or the like. The processor of the electronic device 130 can be any suitable processing device configured to run or execute a set of instructions or code (e.g., stored in the memory) such as a GPP, CPU, APU, ASIC, and/or the like. As such, the processor can run or execute a set of instructions or code stored in the memory associated with using a PC application, a mobile application, an Internet web browser, and/or the like. For example, in some embodiments, the processor can execute instructions or code stored in the memory associated with using any suitable file reader program and/or a file editor program or application such as but not limited to, for example, Microsoft Office Suite™ and/or the like, as described in further detail herein.

The communication interface of the electronic device 130 can be any suitable combination of software and/or hardware configured to place the electronic device 130 in communication with the network 105. For example, in some embodiments, the electronic device 130 can include one or more network interface cards or the like such as, for example, an Ethernet port, a WiFi® radio, a Bluetooth® radio, a NFC radio, a cellular radio, and/or any other suitable network interface.

The user interface of the electronic device 130 may be, for example, an output device such as a display, a speaker/microphone, and/or the like. For example, the user interface can be a display such as a cathode ray tube (CRT) monitor, a liquid crystal display (LCD) monitor, a light emitting diode (LED) monitor, and/or the like that can graphically represent any suitable portion of the system 100 (e.g., a graphical user interface (GUI) associated with a PC application, mobile application, and/or the like). In some embodiments, such a display can be and/or can include a touch screen configured to receive a haptic user input. For example, in some embodiments, the electronic device 130 can be a tablet, a smartphone, and/or a touch-enabled PC having at least one touch-sensitive screens or displays. In other embodiments, the electronic device 130 need not include a direct user interface as described. In such embodiments, the electronic device 130 may be, for example, a device operating programmatically (e.g., without direct user interaction), a device operated remotely, a virtual machine, and/or the like.

As described in further detail herein, the electronic device 130 may be used to create, access, edit, save, etc. one or more files that can be accessible via the network 105. For example, in some instances, the communication established between the electronic device 130 and the network 105 can allow a remote user (e.g., an administrator or authorized user, or an unauthorized user, attacker, or “hacker”) to access files at least temporarily stored on the electronic device 130 (e.g., at least temporarily stored in memory). In other instances, the electronic device 130 may be used to access, download, upload, etc. a file saved and/or stored on, for example, a file management server, the host device 110, and/or on any other suitable device in communication with the network 105.

As shown in FIG. 1, the system 100 includes and/or may be configured to transmit data associated with one or more resources 140. While a single resource 140 is shown in FIG. 1, it should be understood that the system 100 may include any suitable number of resources. In some embodiments, the resource 140 can be a file or a collection of data that may be embedded into a file and used to track the file and/or a triggering event associated with the file (e.g., the file being accessed). For example, in some embodiments, the resource 140 can be an image file or the like. In such embodiments, the image can be a small and/or hidden image otherwise unnoticed by a user of a device on which the image is opened. For example, in some embodiments, the resource 140 may be similar to a “web beacon or web bug” usually inserted in a web page or email.

The resource 140 may be stored and/or saved at any suitable location within the network 105 and/or on any suitable device in communication with the network 105. For example, in some embodiments, the resource 140 can be stored in a database and/or in or by a server (e.g., a resource server) in communication with the network 105. In other embodiments, the resource 140 may be stored in or by, for example, the host device 110 and/or the database 120. As described in further detail herein, the resource 140 may be stored and/or saved such that it has a known and/or predetermined network location. For example, in some embodiments, the resource 140 can be stored and/or saved within the network 105 such that a known or predetermined URI can be used to identify, communicate with, and/or access the resource 140. Similarly, in instances in which the system 100 includes multiple resources 140, each resource may have and/or may be associated with it unique URI. As described in further detail herein, any suitable device in communication with the network 105 (e.g., the host device(s) 110 and/or the electronic device(s) 130) may be configured to insert and/or tag a file accessed by that device with a URI beacon, tag, etc. associated with the resource 140. Moreover, in response to a triggering event (e.g., creating a file, opening a file, editing a file, saving a file, moving a file, etc.), the URI is configured to instruct the electronic device 130 (or a software application or agent run of the electronic device 130) or the host device 110 (or a software application or agent run of the electronic device 130) to initiate a download of the resource 140 to the electronic device 130.

As described in further detail herein, the transmission or sending of a request(s) to download the resource 140 and/or the transmission or sending of the resource 140 itself, in turn, results in the host device 110 receiving data associated with the file and/or the electronic device 130 accessing the file, which the host device 110 can (1) store in the database 120 and (2) analyze to determine information associated with access of the file. For example, the host device 110 may determine information associated with a user or device used to access a beacon or tagged file; an estimated time in which a beaconed or tagged file was removed from an authorized network or and authorized portion of a network (e.g., an estimated time of breach); a hostname or system on which the beaconed or tagged file existed during the estimated time of breach; an approximate geographic area of a user or device that accessed the beaconed or tagged file; one or more patterns associated with authorized or unauthorized access of beaconed or tagged files; and/or the like. In addition, the host device 110 may determine and/or predict potential vulnerabilities of a network, system, and/or portion thereof, can determine and/or predict files of interest based on one or more patterns of access, and can create “honeypot” files and/or the like having enhanced security or subject to enhanced monitoring.

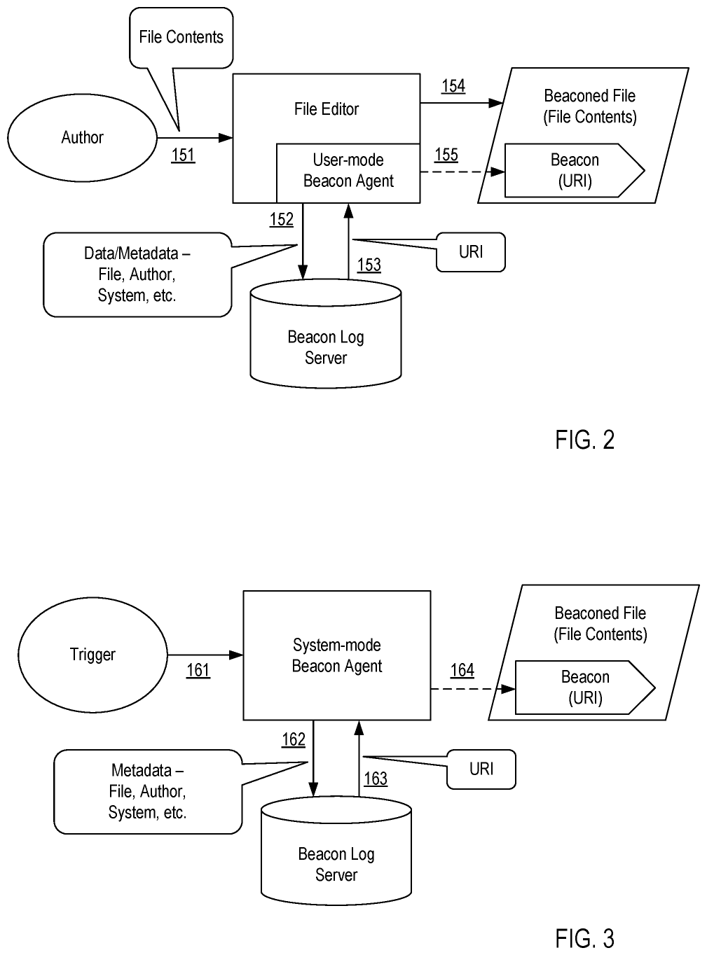

The system 100 described above with reference to FIG. 1 may be used in any suitable manner to detect, track, and analyze access to digital information and/or files on or within the network 105. For example, FIGS. 2-5 are each a schematic diagram illustrating an implementation of the system 100 according to a specific embodiment. While specific implementations are described herein with reference to FIGS. 2-5, it should be understood that such implementations are presented by way of example only and not limitation. Moreover, in some instances, any number of features, characteristics, and/or arrangements of the implementations described with reference to FIGS. 2-5 may be combined in any suitable manner.

FIG. 2, for example, illustrates an implementation of the system 100 in which an Author using, for example, the electronic device 130 creates and/or edits a beacon-ready file and in which the beacon agent is, for example, a local beacon agent (identified in FIG. 2 as “User-mode Beacon Agent”). In this context, the Author can be a user that uses or that previously used the electronic device 130 and/or a file editor stored and/or executed on the electronic device 130 to create the beacon-ready file. In other instances, however, an Author need not necessarily refer to the original creator of the file. In either instance, the Author may refer to a user of the electronic device 130 that using a file editor to create, edit, and/or modify the file (e.g., in contrast to a Reader who uses a file viewer or reader to view the file without modifying). As described above, the file editor may be any suitable program, application, and/or the like configured to be compatible with a beacon-ready file type and the beacon agent can be, for example, an add-in or plugin installed in or executed by the file editor.

In the example, shown in FIG. 2, the Author can specify, define, create, and/or modify the contents of the file, as indicated by the arrow 151. In some instances, when the file is created, when the file is saved, and/or after a predetermined period of time (e.g., a triggering event), the beacon agent running within, on, and/or executed by the file editor sends, for example, a resource request, data and/or metadata about the file, data associated with the electronic device, data associated with the Author, etc. to the host device 110 (e.g., via the network 105), as indicated by the arrow 152. As described above with reference to FIG. 1, the host device 110 may be one or more servers or the like configured to send and/or receive information via the network 105. In the example shown in FIG. 2, the host device 110 can be and/or can include a Beacon Log Server. Thus, the Beacon Log Server may be configured to receive and/or collect the information, data, and/or metadata sent by the beacon agent. In some instances, the information can include, for example, the hostname of the electronic device 130, the Author's username, the system time on the electronic device 130, the beaconed file's name and path in the file system, the beaconed file's file type, operating environment specific information (e.g., if operating in an Microsoft Active Directory Domain or other operating environment information), the Author's Windows Security Identifier (SID), any Organizational Units (OUs) and/or groups to which the Author and/or the electronic device 130 belongs, other identifiers (e.g., a company could be divided into different units with separate identifiers, and/or any other unique identifiers associated with a Windows, Macintosh, Linux, or cloud-based environment), and/or the like.

In general, the Beacon Log Server stores the information and/or data, for example, in the database 120 and/or any other storage device. In addition, the Beacon Log Server may send information and/or data associated with the URI for a resource (e.g., the resource 140) and/or sends the resource itself to the beacon agent, as indicted in FIG. 2 by the arrow 153. For example, in some instances, the Beacon Log Server may send to the beacon agent the URI (or data associated with or representing the URI) and an instruction to insert or embed the URI in the beaconed file. In some instances, the Beacon Log Server can assign a Universally Unique Identifier (UUID) to the file and/or the data received from the beacon agent about the file. In such instances, the Beacon Log Server may store the assigned UUID (e.g., in the database) and associate the assigned UUID with the data received from the beacon agent. In addition, the Beacon Log Server can send the UUID and/or data associated with or representing the UUID to the beacon agent, which in turn, may include the UUID in the tag or beacon inserted into the file.

In some instances, as the beacon agent and the Beacon Log Server communicate (e.g., via the network 105), the Author can create, edit, and/or modify the contents of the file in a substantially parallel and/or concurrent process, as indicated in FIG. 2 by the arrow 154. That is to say, in some instances, the beacon agent can send information, data, and/or signals to and/or can receive information, data, and/or signals from the Beacon Log Server as the Author creates, edits, and/or modifies the contents of the beaconed file. In some instances, the beacon agent can be executed (e.g., by the electronic device 130) in a background process and/or in a process that does not require user input and/or intervention. Indeed, the beacon agent may be executed in one or more hidden processes and/or in one or more process otherwise unknown or substantially unnoticeable to the Author (or user).

In some instances, the beacon agent can be configured to at least temporarily store and/or cache the URI and/or UUID data received from the Beacon Log Server until an event or action triggers the beacon agent to insert and/or embed a beacon, tag, and/or URI into the beaconed file. For example, in some instances, such a triggering event can be associated with the Author saving the beaconed file. In other instances, the beacon agent can insert and/or embed the beacon, tag, and/or URI in the beaconed file in response to receiving the data and/or instructions from the Beacon Log Server. That is to say, receiving the data from the Beacon Log Server can be a triggering event that triggers the beacon agent to insert the beacon into the file. In either instance, the beacon agent can insert and/or embed the beacon or tag, which can include, for example, the URI for the resource, the UUID associated with the beacon agent and/or beaconed file, and/or any other suitable data or instructions, as indicated in FIG. 2 by the arrow 155. Accordingly, the system 100 may use a “User-mode Beacon Agent” to insert a beacon into any suitable file.

FIG. 3 illustrates an implementation of the system 100 in which a beacon agent of the system 100 is included in and/or executed by a system device (e.g., the host device 110) or a device other than the electronic device 130. In the example, shown in FIG. 3, a user (e.g., an Author or a Reader) can access a beaconed file stored within and/or accessible via a network (e.g., the network 105). That is to say, the user can access a file including a previously inserted or embedded beacon. In other instances, an Author can create a beacon-ready file configured to be stored within and/or accessible via the network. That is to say, the Author can create a file into which a beacon is configured to be inserted or embedded. As such, the user can view the file contents (e.g., the user is an Author or a Reader) or can edit and/or modify the file contents (e.g., the user is an Author and not a Reader).

In some instances, an event can trigger the system 100 to perform one or more actions, processes, and/or procedures, as indicated in FIG. 3 by the arrow 161. For example, in some instances, a triggering event can be a request to open or download a beaconed file stored within and/or accessible via the network, the creation of a beacon-ready file, the saving of a beaconed file or beacon-ready file, the passage of a predetermined period of time, and/or any other suitable triggering event. In addition, the triggering event can trigger the system 100 and/or the beacon agent to insert and/or embed a beacon in the beacon-ready file or to update or modify the beacon previously inserted and/or embedded into the beaconed file. As described above, in the example shown in FIG. 3, the beacon agent is configured to be executed by a system device such as the host device 110 or the like (e.g., described in FIG. 3 as a “System-mode Beacon Agent”). The triggering event can initiate and/or trigger the beacon agent to perform one or more actions or processes associated with inserting, embedding, and/or updating a beacon into the file.

The triggering event may result in the beacon agent receiving, collecting, and/or retrieving data and/or metadata associated with the beaconed file or beacon-ready file, the user, the electronic device 130 or any other device accessing the beaconed file or beacon-ready file, and/or any other suitable data, as described above with reference to FIG. 2. After receiving, collecting, and/or retrieving the data and/or metadata, the beacon agent (e.g., the System-mode Beacon Agent) sends the data and/or metadata to the host device 110, as indicated by the arrow 162. As shown in FIG. 3, the host device 110 can be and/or can include the Beacon Log Server. Thus, the Beacon Log Server is configured to receive and/or collect the information, data, and/or metadata sent by the beacon agent. As described in detail above with reference to FIG. 2, the Beacon Log Server can be configured to store the information, data, and/or metadata (e.g., in the database 120) and to send information, data, and/or instructions associated with a URI for a resource (e.g., the resource 140) and/or to send the resource itself to the beacon agent, as indicted in FIG. 3 by the arrow 163. In some instances, the Beacon Log Server can also assign a UUID to the beaconed or beacon-ready file and/or the data received from the beacon agent about the file and can send the UUID and/or data associated with or representing the UUID to the beacon agent, which in turn, may include the UUID in the tag or beacon inserted into the file.

In response to receiving the data and/or instructions from the Beacon Log Server, the beacon agent (e.g., the System-mode Beacon Agent) may insert and/or embed the beacon, tag, and/or URI in the file, as indicated in FIG. 3 by the arrow 164. More particularly, in instances in which the file is a beacon-ready file (i.e., a file that does not yet include a beacon), the beacon agent can insert and/or embed a new beacon, which results in the file becoming a beaconed file. In instances in which the file is a beaconed file (i.e., a file that has a previously inserted or embedded beacon), the beacon agent can update and/or modify the beacon with any new information and/or data received from the Beacon Log Server. In other instances, the beacon agent can replace and/or overwrite an existing beacon with a new or updated beacon. Accordingly, the system 100 can use a “System-mode Beacon Agent” to insert a beacon into any suitable file.

While the system 100 is described above with reference to FIG. 3 as acting in response to a triggering event associated with, for example, the electronic device 130 creating, accessing, and/or saving a beaconed file or a beacon-ready file, in other instances, the triggering event need not be associated with and/or need not result from an action performed by the electronic device 130. For example, in some embodiments, the system 100 (or the host device 110 thereof) can define and/or identify specific beaconed files stored within the network 105 on which the beacon agent is configured to act. In some instances, the beaconed files may be defined and/or identified according to an access policy, a set of instructions, and/or the like. Furthermore, the triggering event may be defined and/or included in the access policy, the set of instructions, and/or the like. For example, the access policy and/or set of instructions can establish and/or define a schedule for monitoring, inserting, and/or updating a beaconed file. As such, after a predetermined time period and/or otherwise according to the defined schedule, the beacon agent may collect data associated with the beaconed file, may send the data to the Beacon Log Server, may receive updated information and/or data associated with beacon, URI, and/or resource, and may insert, embed, and/or update the beacon for the beaconed file. In other instances, a triggering event can be any suitable external event such as, for example, an indication and/or identification of unauthorized access of the network or a portion of the network (e.g., the network 105), a threshold number of failed attempts to access the network, a request to access the network from an unauthorized geographical location, etc. In other instances, a triggering event can be in response to a manual or user input (e.g., an administrator or analyst initiates the triggering event). In still other instances, the triggering event can be any suitable event that need not include a beaconed file actually being accessed or an attempt to access a beaconed file. For example, the beacon agent can be configured to collect data associated with the file programmatically and/or otherwise accordingly to a predefined schedule (e.g., without user initiation and/or intervention).

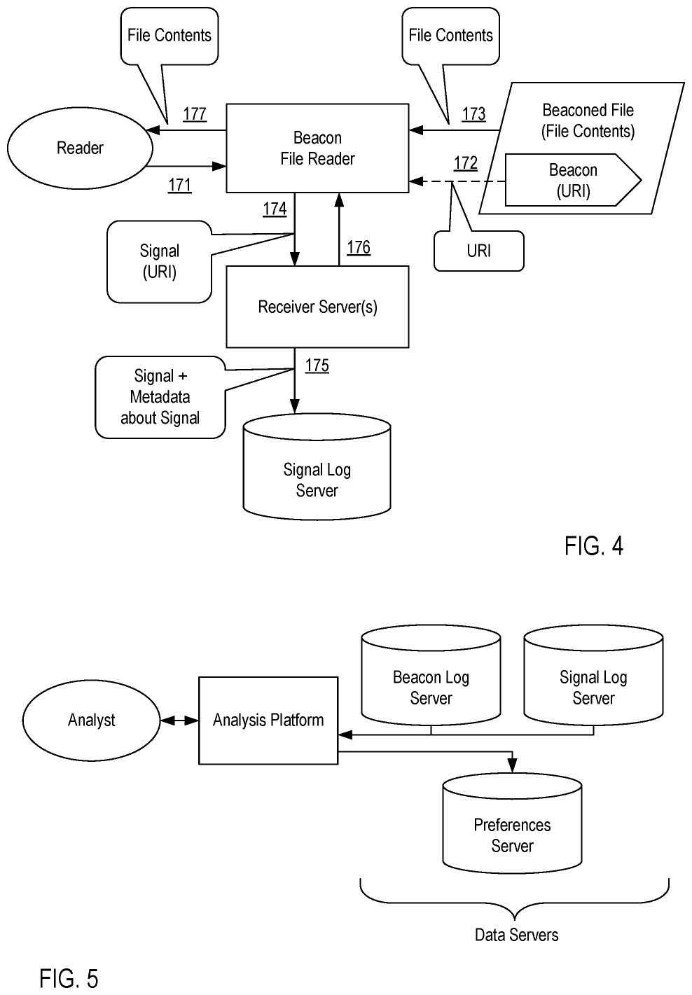

FIG. 4 illustrates an implementation of the system 100 in which a Reader reads a beaconed file with a beacon file reader and/or file viewer. That is to say, the system 100 is configured to present a beaconed file to a user authorized to read or view the beaconed file without editing the beaconed file. As described above with reference to FIG. 1, in some instances, a Reader (e.g., user) can use a file reader or viewer program, which can have capabilities limited to reading or viewing the beaconed file. In other instances, a Reader can use a file editor program, which is otherwise capable of editing the beaconed file. In some such instances, authorization to edit the beaconed file may be based on, for example, the Reader's user credentials and/or authorizations.

Accordingly, in the example shown in FIG. 4, the Reader may use the Beacon File Reader to open the beaconed file, as indicated by the arrow 171. In some instances, the request to open the beaconed file and/or the opening of the beaconed file can be, for example, a triggering event. As described above with reference to FIGS. 2 and 3, the triggering event (i.e., the opening of or the request to open the beaconed file) may result in Beacon File Reader identifying the beacon embedded in the beaconed file, as indicated in FIG. 4 by the arrow 172. In addition to identifying and/or reading the beacon, the Beacon File Reader can also receive and/or read the contents of the file, as indicated in FIG. 4 by the arrow 173. In response to instructions within the beacon (e.g., the URI), the Beacon File Reader can perform one or more actions, processes, and/or procedures. For example, the Beacon File Reader (and/or a beacon agent included therein) can send a signal to, for example, the host device 110.

As described above, the host device 110 may include one or more devices and/or servers configured to send, receive, and/or store data. In the example shown in FIG. 4, the host device 110 may be and/or can include, for example, one or more Receiver Server(s) and at least one Signal Log Server. The Receiver Server(s) can be one or more servers configured to receive signals, data, information, instructions, etc. from and/or send signals, data, information, instructions, etc. to the Beacon File Reader. More specifically, the Receiver Server(s) may be one or more devices and/or one or more software applications executed by hardware (e.g., the host device 110) configured to listen for and optionally respond to Signals received from a Beacon File Reader. In addition, the Receiver Server(s) are configured to collect information about the Reader, including the Reader's host computer (e.g., the electronic device 130), physical location, specific application used as the Beaconing File Reader, etc. In turn, the Receiver Server(s) pass the collected information to the Signal Log Server, which stores the information (e.g., in the database 120 or the like).

In the example shown in FIG. 4, a Reader may use an electronic device that is outside of the perimeter of the network (e.g., the network 105). Accordingly, the Receiver Server(s) and/or the hardware executing the Receiver Server(s) can be connected to the Internet (e.g., via any suitable communication interface such as the communication interface 118 described above with reference to FIG. 1) to allow the Receiver Server(s) to communicate with the electronic device used by the Reader. Moreover, the system 100 and/or the host device 110 may include any suitable number of different Receiver Servers, each of which is configured to receive a specific Signal (e.g., a Signal sent via a specific protocol or modality) and/or to collect information about the Reader via one or more sources or modalities. For example, in some embodiments, the system 100 can include a Domain Name System (DNS) Receiver Server, a Hyper-Text Transfer Protocol (HTTP) Receiver Server, a Common Internet File System/Server Message Block (CIFS/SMB) Receiver Server, a Microsoft Media Server (MMS) Receiver Server, and/or any other suitable Receiver Server.

More specifically, in some embodiments, a DNS Receiver Server is a DNS resolver designated to authoritatively translate the URI and/or a uniform resource locator (URL) specified in the beacon into an Internet Protocol (IP) address (per RFC 1034 and RFC 1035). Thus, when a Beacon File Reader requests a resource specified in a beacon, the electronic device executing the Beacon File Reader looks up the IP address for the URI of the beacon, which is routed through a series of DNS resolvers to the DNS Receiver Server of the system 100. In general, the IP address associated with the Signal received by the DNS Receiver Server will be that of the electronic device (e.g., the electronic device 130) on which the Beacon File Reader opened the beaconed file or a proxy server through which the resource request was routed. In some instances, the Signal's source IP address may be, for example, the last DNS resolver in the routing chain, which in turn, may be used to at least infer the geographic region of the Reader. In addition, the Signal may include, for example, the requesting devices subnet or any other suitable information.

In some embodiments, an HTTP Receiver Server responds to HTTP (and/or HTTP Secure (HTTPS)) resource requests in accordance with RFC 2818 and RFC 2616. In some instances, the Beacon File Reader may include in the Signal a user-agent string specifying the Beacon File Reader software version and operating system version. In addition, the HTTP Receiver Server can receive any other suitable information sent within the Signal.

In some instances, a CIFS/SMB Receiver Server responds to CIFS/SMB resource requests. In some instances, the instructions within the beacon can instruct the Beacon File Reader to attempt to authenticate in accordance with the CIFS/SMB protocol. Accordingly, the CIFS/SMB Receiver Server collects information about the Reader and the Reader's system, including, for example, a username, a system name, a password hash, operating system version, and/or any other suitable information.

The Beacon File Reader can send a Signal to one or more Receiver Server(s) according to the instructions within the beacon and/or according to the URI, as indicated by the arrow 174. In the example shown in FIG. 4, the Signal may be any network action sent by the Beacon File Reader in response to opening the beaconed file and/or in response to instructions within the beacon embedded in the beaconed file. Moreover, the Signal can include and/or can provide information about the beaconed file, the Author of the beaconed file, the Reader, a host or network environment of the Author at the time the beacon was inserted, and/or any other suitable information. In some instances, such information can be conveyed explicitly. For example, the Signal and/or the URI resource request may include a parameter which explicitly states “BeaconedFileName=<name of file>” and/or any other suitable file name format. In other instances, such information can be conveyed by reference. For example, the Signal and/or the URI resource request may include a UUID sent to the Beacon Log Server when the beacon agent inserted the beacon (e.g., as described above with reference to FIGS. 2 and/or 3). In still other instances, such information can be conveyed implicitly. For example, the system 100 can infer information by examining the Signal and/or the URI resource request (e.g., the system 100 can infer the application used as the Beacon File Reader from the format of the Signal and/or data included therein, and/or can infer any other suitable information).

After receiving the URI resource request and/or data from the Beacon File Reader, the Receiver Server(s) can infer and/or determine any additional data and/or metadata associated with the beaconed file, the Beacon File Reader, the Reader, and/or the like. The Receiver Server(s) can then send the Signal and any additional data and/or metadata associated with the Signal to the Signal Log Server, as indicated in FIG. 4 by the arrow 175. The Signal Log Server, in turn, stores the data (e.g., in the database 120). While the Receiver Server(s) and the Signal Log Server are shown as being separate servers, in other embodiments, the Receiver Server(s) and the Signal Log Server can be combined as a signal device and/or as a signal software application executed by a device (e.g., the host device 110). In some embodiments, the arrangement of the Receiver Server(s) and the Signal Log Server can be such that the Receiver Server(s) are connected to the Internet while the Signal Log Server is isolated from the Internet (e.g., limited to communications within the network and/or an Intranet). As indicated in FIG. 4 by the arrow 176, the Receiver Server(s) are also configured to send data associated with the requested resource (e.g., the resource 140) back to the Beacon File Reader. In some instances, the Receiver Server(s) can respond to the Beacon File Reader using the protocol used to send the Signal.

As described above, the Beacon File Reader may be configured to read and/or receive the contents of the beaconed file (e.g., as indicated by the arrow 173). In some instances, once the Beacon File Reader reads the content of the beaconed file, the Beacon File Reader may present the file contents to the Reader (e.g., via an output device or display), as indicated in FIG. 4 by the arrow 177). In some instances, the Receiver Server(s) and/or any suitable portion of the host device 110 may perform one or more authentication and/or authorization processes, procedures, and/or checks based on the information contained within the Signal. For example, the Receiver Server(s) can verify whether the Reader or the Beacon File Reader is authorized to view the contents of the beaconed file. In some instances, any of the information contained and/or included in the Signal can be checked against one or more access policies, whitelists, blacklists, etc. In some instances, if the Receiver Server(s) and/or the system 100 determines that the Reader is an “Authorized Reader” (e.g., a Reader authorized to read the contents of the beaconed file and/or a device, system, and/or network on which the contents of the beaconed file are authorized to be presented), the response sent from the Receiver Server(s) to the Beacon File Reader can include an authorization to present the contents of the beaconed file to the Reader.

Conversely, if the Receiver Server(s) and/or the system 100 determines that the Reader is an “Unauthorized Reader,” the response sent from the Receiver Server(s) to the Beacon File Reader can instruct the Beacon File Reader not to present the contents of the beaconed file. Non-limiting examples of an Unauthorized Reader may include (1) an employee who is authorized to read a certain beaconed file from a work computer, but who improperly reads a beaconed file from home; (2) an employee who is authorized to read some files at his workplace, but who reads a certain beaconed files at his workplace that he is not authorized to read; (3) a thief or attacker who reads a stolen or surreptitiously obtained beaconed file from a machine in an unauthorized geographic location (e.g., a foreign country).

As described above with reference to FIGS. 2-4, the system 100 may be used to collect data associated with beaconed files and/or devices or users accessing the beaconed files. In some instances, the system 100 may also be used to analyze such data and/or information to detect, track, and/or protect the beaconed files. For example, FIG. 5 illustrates an implementation of the system 100 in which data stored in, for example, one or more Beacon Log Servers and/or one or more Signal Log Servers is provided to an Analysis Platform configured to analyze the data.

The Analysis Platform may be any suitable device and/or software application executed by hardware configured to record, annotate, enrich, and/or secure data in the Signal Log Server(s) and Beacon Log Server(s). For example, the Analysis Platform may aggregate the data in the Signal Log Server(s) and Beacon Log Server(s), can analyze the aggregated data based on any suitable policy and/or analysis method, and can present the aggregated and analyzed data to an Analyst (e.g., on a display of an electronic device). Furthermore, the Analysis Platform may be configured to enrich, expand upon, and/or otherwise extrapolate from the data stored in the Data Servers. For example, in some instances, the Analysis Platform may enrich the data stored in the Data Servers by associating additional information with the information stored in the Beacon Log Server and Signal Log Server. Such additional information can include, for example, IP addresses of relevant devices, geographic locations associated with those IP addresses, ownership information associated with a device or IP address, characterization of historical use (e.g., by bad actors, thieves, and/or attackers, whitelists or lists of IP address to ignore, blacklists or lists of IP address to flag or block, etc.

The Analysis Platform may present aggregated, patterned, sorted, and/or analyzed data to the Analysts in a variety of ways including but not limited to dashboards, an application program interface (API), and reports. In this context, an Analyst may be a human who uses the Analysis Platform to examine information contained in the Data Servers of the system 100 to (1) identify Signals which indicate a beaconed file has be opened by an Unauthorized Reader; (2) gather information related to the Unauthorized Reader; (3) gather statistical information about Authors, Readers (authorized or unauthorized), the applications they use, and the beaconed files they access.

By way of example, the Analyst can use the Analysis Platform to search the Data Servers, including and/or excluding results based on characteristics including but not limited to specific application used as a Beacon File Reader; presumed geographic location of a Reader (the Analyst can include or exclude results that fall within a certain geographic area); a hostname from which a Signal was received; a Reader's username or password; the file type of an accessed beaconed file; the time a Signal was received (e.g., from a Beacon File Reader); the time a beacon was inserted or embedded into a file; beaconed files with the same Author; beaconed files created at the same time (or within a time range around the same time); and/or the like. Moreover, the Analysis Platform can determine and/or can allow an Analyst to determine, for a given signal, the earliest and latest time at which a beaconed file could have left the system or network; the hostname or system on which beaconed file existed during that timeframe; any other Signals which on their own may not indicate access by an Unauthorized Beacon File Reader but do so indicate when considered as a whole (e.g., multiple files associated with a specific file path being opened in a new geographic area), and/or any other suitable information. In some instances, determining such information can increase the chances of identifying Unauthorized Beacon File Readers, determining the way a beaconed file left or was removed from the system and/or network, potentially identifying Unauthorized Readers, thieves, and/or misappropriating data abusers, and/or the like.

As the Analyst examines Signals and/or data associated with Signals, and indicates which are of interest and which can be ignored, the Analysis Platform can record such interests and/or preferences in the Preferences Server. Similar to the Beacon Log Server(s) and/or the Signal Log Server(s), the Preferences Server(s) can be a device and/or a software application executed by hardware that stores a collection of information about an Analyst's preferences including, for example, which specific Signals and/or which general characteristics of Signals are important and unimportant. Moreover, based on analyzing the aggregated data, the Analyst and/or the Analysis Platform can define and/or present an alert if and/or when an analysis satisfies a criterion indicative of data loss and/or unauthorized access. In some instances, such alerts can be present in a dashboard of the Analysis Platform and/or can be communicated or sent to interested parties such as, for example, administrators or the like.

While the Analysis Platform is described above as presenting data to a human Analyst who then further analyzes the data, in other embodiments, the Analysis Platform may include, implement, and/or execute any suitable set of instructions to analyze the aggregated data. Moreover, in some instances, the Analysis Platform may employ any suitable machine learning, artificial intelligence, predictive analytics, and/or the like to analyze the aggregated data, determine current and/or predicted vulnerabilities and/or threats, determine, define, and/or adjust security protocols or measures, determine, define, and/or adjust monitoring settings, and/or the like.

In some instances, the Analysis Platform and/or an Analyst utilizing the Analysis Platform can, for example, determine and/or define one or more patterns of access of the beaconed files within a network. In some instances, further analysis can reveal, for example, characteristics of beaconed files that appear to be of interest to one or more unauthorized readers. In such instances, the Analysis Platform, the Analyst, and/or the system 100 can create a beaconed file having at least some of the characteristics of interest. In addition, the beaconed file can include, for example, a beacon having enhanced security measures, which in turn, can result in additional information being collected if an unauthorized reader attempts to access the beaconed file. In other words, the Analysis Platform can be used to create “honeypot” files based on one or more patterns and/or characteristics of the aggregated and/or analyzed data. In some instances, such “honeypot” files can aid in determining the identity of unauthorized readers and/or the like.

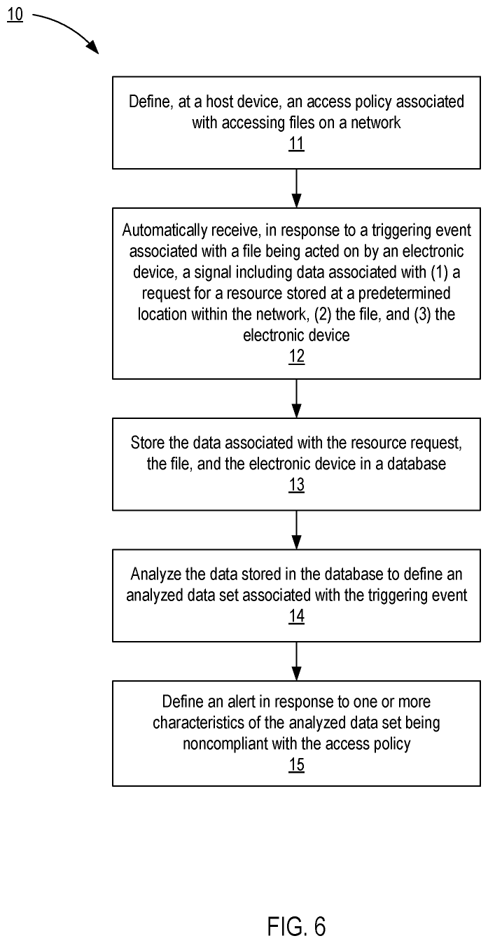

FIG. 6 is a flowchart illustrating a method 10 for detecting and tracking access to digital information to identify and limit data loss according to an embodiment. The method 10 can be implemented on any suitable system and/or network such as those described herein. For example, in some embodiments, the method 10 can be implemented in or on the system 100 described above with reference to FIGS. 1-5. Accordingly, the method 10 can be used to insert, embed, read, and/or act on one or more beacons or tags within a file accessible via a network (e.g., a beaconed file or a beacon-ready file, as described above).

The method 10 includes defining, at a host device, an access policy associated with accessing files on a network, at 11. The host device can be any suitable device and/or any suitable software application executed by the hardware of such a device. For example, in some embodiments, the host device can be similar to and/or substantially the same as the host device 110 described above with reference to FIGS. 1-5. Likewise, the network can be any suitable network such as the network 105. The access policy can be any suitable policy and/or instructions used to define and/or determine whether to perform one or more actions and/or processes in response to satisfying a given criteria. For example, in some embodiments, access policy may include a list of authorized users, readers, devices, network locations, geographic locations, etc. and/or a list of unauthorized users, readers, devices, network locations, geographic locations, etc. Moreover, the access policy can define one or more actions to be performed in response to adherence to the access policy and/or violation or non-compliance with the access policy.

As shown in FIG. 6, in some variations, the host device automatically receives a signal in response to a triggering event associated with a file at least temporarily stored on an electronic device, at 12. As described above, the file can be, for example, a beaconed or beacon-ready file and the triggering event can be, for example, creating the beaconed or beacon-ready file, the accessing, opening, editing, modifying, or saving of the beaconed or beacon-ready file, the passage of a predetermined period of time (e.g., either relative to when the file was accessed or regardless of any interaction with the file), and/or the like. In some embodiments, the signal received by the host device can include data associated with (1) a request for a resource stored at a predetermined location within the network (e.g., identified by a specific URI within the beacon), (2) the beaconed or beacon-ready file, and (3) the electronic device used to access the beaconed or beacon-ready file.

The data associated with the resource request, file, and the electronic device is stored in a database, at 13. The database may be any suitable data storage structure, server, and/or the like. For example, in some embodiments, the database can be substantially similar to the database 120 described above with reference to FIGS. 1-5. In some variations, the host device analyzes the data stored in the database to define an analyzed data set associated with the triggering event, at 14. For example, as described above with reference to FIG. 5, the system may include an analysis platform or the like that can be used to aggregate and/or analyze data stored in the database (or one or more data servers). In some instances, such an analysis can include, for example, comparing one or more characteristics and/or patterns of access against authorized characteristics and/or patterns identified in the access policy. Furthermore, the host device can define an alert in response to the one or more characteristics of the analyzed data set being noncompliant with the access policy, at 15. For example, as described above, the analysis platform can provide an alert to an analyst (e.g., in or on a dashboard of the analysis platform) or the analyst can define the alert and can send and/or provide the alert to one or more interested users (e.g., a system administrator or the like). Accordingly, the method 10 may be used to detect and track access of a beaconed file and can define and/or provide any suitable alert in response to an unauthorized access or an unauthorized attempt to access the beaconed file.

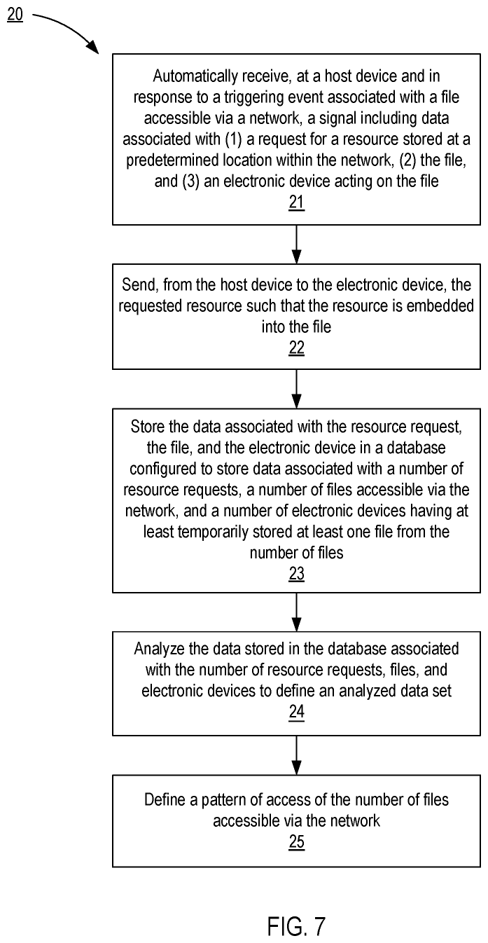

FIG. 7 is a flowchart illustrating a method 20 for detecting and tracking access to digital information to identify and limit data loss according to an embodiment. As described above with reference to the method 10 shown in FIG. 6, the method 20 may be implemented on any suitable system and/or network such as, for example, the system 100 described above with reference to FIGS. 1-5. Accordingly, the method 20 may be used to insert, embed, read, and/or act on one or more beacons or tags within a file accessible via a network (e.g., a beaconed file or a beacon-ready file, as described above).

The method 20 includes automatically receiving a signal at a host device in response to a triggering event associated with a file at least temporarily stored on an electronic device, at 21. As described above, the host device can be similar to or substantially the same as the host device 110 and the electronic device can be similar to or substantially the same as the electronic device 130. The file can be, for example, a beaconed or beacon-ready file and the triggering event can be, for example, creating the beaconed or beacon-ready file, the accessing, opening, editing, modifying, or saving of the beaconed or beacon-ready file, the passage of a predetermined period of time (e.g., either relative to when the file was accessed or regardless of any interaction with the file), and/or the like. In some embodiments, the signal received by the host device can include data associated with (1) a request for a resource stored at a predetermined location within the network (e.g., identified by a specific URI within the beacon), (2) the beaconed or beacon-ready file, and (3) the electronic device used to access the beaconed or beacon-ready file.

In some variations, the host device sends the requested resource to the electronic device such that the resource is embedded into the file, at 22. In some embodiments, the host device can receive the request for the resource and based on the request and/or a URI included in the request can send the resource and/or data associated with or representing the resource to the electronic device. In some embodiments, the electronic device can include and/or can be configured to execute a beacon agent or the like that can receive the data from the host device and insert and/or embed a beacon including the resource and/or the URI of the resource in the file.

In addition, the host device stores the data associated with the resource request, the file, and the electronic device in a database, at 23. The database can be, for example, substantially similar to the database 120 described above with reference to FIG. 1. Moreover, the data associated with the resource request, the file, and the electronic device is included in data, stored in the database, associated with a number of resource requests, a number of files accessible via the network and a number of electronic devices having at least temporarily stored at least one file from the number of files.

The data stored in the database associated with the resource requests, the files, and the electronic devices is analyzed to define an analyzed data set, at 24. For example, as described above with reference to FIG. 5, the system can include an analysis platform or the like that can be used to aggregate and/or analyze data stored in the database (or one or more data servers). In some instances, such an analysis can include, for example, defining a pattern of access of the files accessible via the network, at 25. As described above, in some instances, analyzing the data stored in the database and defining the pattern of access of the files can, for example, allow an analyst and/or administrator to determine characteristics of data loss, predict future data loss, identify unauthorized readers, fortify and/or adjust security measures in a targeted manner, and/or the like. Accordingly, the method 20 may be used to detect and track access of network or system files and can define and/or determine a pattern of access, which in turn, can be used to identify unauthorized readers and/or the like.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. For example, any of the systems, devices, and/or methods can be performed, executed, and/or implemented in any suitable physical, cloud-based, and/or virtual environment. For example, in some embodiments, a host device such as the host device 110 can be one or more physical machine(s) forming a server or group of servers. In another embodiment, a host device such as the host device 110 can be one or more virtual machine instances and/or cloud-based systems. Similarly, an electronic device such as the electronic device 130 can be a physical machine such as a client device (e.g., a PC, a laptop, a tablet, a smartphone, a wearable electronic device, etc.) or can be a virtual, cloud-based, and/or remote device. Although various embodiments have been described as having particular features and/or combinations of components, other embodiments are possible having a combination of any features and/or components from any of embodiments described herein.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above. Moreover, the methods described herein are not limited to the explicitly recited events, steps, and/or procedures unless the context clearly indicates that the method is intended to include only those events, steps, and/or procedures recited. That is to say, any of the methods described herein can include additional steps that may not be explicitly recited.

For example, some of the methods and/or events described herein include and/or involve sending one or more signals and/or communications between at least two electronic devices (e.g., a user device and a host device) via a network. In some instances, however, a network connection may be interrupted, may drop out, may lack sufficient signal strength, and/or may otherwise be impeded. In such instances, a first electronic device (e.g., a user device such as the electronic device 130) can be configured to at least temporarily store and/or cache the data intended to be sent to a second electronic device (e.g., a host device or server such as the host device 110) via the network (e.g., the network 105). Accordingly, such a method, though not explicitly described, can include additional events, steps, and/or procedures associated with at least temporarily storing and/or caching the data and attempting to send the data at a later time (e.g., once the network connection has been reestablished). In other instances, a method can include modifying the data format and attempting to send the data via a different protocol or modality.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, FORTRAN, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed:

1. A method for detecting and tracking access to digital information to identify and limit data loss, the method comprising:
defining, at a host device, an access policy associated with accessing files on a network;
automatically receiving a signal at the host device in response to a triggering event associated with a file being acted on by an electronic device, the signal including data associated with (1) a request for a resource stored at a predetermined location within the network, (2) the file, and (3) the electronic device acting on the file;
storing the data associated with the resource request, the file, and the electronic device acting on the file in a database;
analyzing the data stored in the database to define an analyzed data set associated with the triggering event; and
defining an alert in response to one or more characteristics of the analyzed data set being noncompliant with the access policy.

2. The method of claim 1, further comprising:
sending, from the host device to the electronic device, a signal associated with the requested resource such that the resource is embedded into the file.

3. The method of claim 1, further comprising:
sending, from the host device to the electronic device, a signal associated with the requested resource such that the file is contained in a container file, the resource being embedded in the container file.

4. The method of claim 1, wherein the triggering event associated with the file is at least one of creating the file, opening the file, saving the file, or the file being accessed for a predetermined time.

5. The method of claim 1, wherein the access policy includes data associated with at least one of a set of authorized users, a set of authorized devices, a set of authorized geographic locations associated with an electronic device accessing the network, an authorized window of time for accessing the file, or a maximum number of access attempts within a given time.

6. The method of claim 1, wherein the data associated with the electronic device acting on the file includes data associated with at least one of an Internet Protocol (IP) address of the electronic device, a geographic location corresponding to the IP address of the electronic device, an operating system of the electronic device, a program being executed on the electronic device and used to access the file, or user credentials under which the electronic device is being operated.

7. The method of claim 1, further comprising:
sending, from the host device to the electronic device, a request for addition data associated with the electronic device in response to the one or more characteristics of the analyzed data set being noncompliant with the access policy.

8. The method of claim 1, further comprising:
analyzing data stored in the database associated with a plurality of files accessed via the network, the file being from the plurality of files; and
defining a pattern of unauthorized access of at least one file from the plurality of files.

9. The method of claim 8, further comprising:
determining subject matter having an increased probability of unauthorized access based at least in part on the pattern of unauthorized access;
creating a honeypot file containing data associated with the subject matter having the increased probability of unauthorized access; and
actively monitoring access of the honeypot file.

10. The method of claim 1, wherein the access policy includes data associated with an authorized geographic region in compliance with a regulatory standard.

11. The method of claim 1, further comprising:
configuring a plurality of files, accessible via the network, to include an instruction operable to cause an application acting on the file to automatically request the resource, the file being from the plurality of files.

12. The method of claim 11, wherein the triggering event is the passage of a predetermined time, the method further comprising:
embedding the resource in the file in response to the triggering event, the resource including an indication of a universally unique identifier (UUID) associated with at least one of the file or the resource; and
storing data associated with the UUID in the database.

13. The method of claim 12, further comprising:
analyzing the data associated with the UUID to determine an initial time the UUID was associated with the file and a final time the UUID was associated with the file.

14. The method of claim 1, wherein the storing of the data associated with the resource request, the file, and the electronic device acting on the file in a database includes storing information associated with at least one of a last user to save the file, a location of the file in a file system, an indication of an existing resource embedded in the file, the electronic device acting on the file, or an indication of an application acting on the file.

15. A method for detecting and tracking access to digital information to identify and limit data loss, the method comprising:
automatically receiving a signal at a host device in response to a triggering event associated with a file accessible via a network, the signal including data associated with (1) a request for a resource stored at a predetermined location within the network, (2) the file, and (3) an electronic device acting on the file;
sending, from the host device to the electronic device, a signal associated with the requested resource such that the resource is embedded into the file;
storing the data associated with the resource request, the file, and the electronic device in a database, the database storing data associated with a plurality of resource requests, a plurality of files accessible via the network, and a plurality of electronic devices having at least temporarily stored at least one file from the plurality of files, the data associated with the resource request, the file, and the electronic device being included in the data associated with the plurality of resource requests, the plurality of files, and the plurality of electronic devices;
analyzing the data stored in the database associated with the plurality of resource requests, the plurality of files, and the plurality of electronic devices to define an analyzed data set; and
defining a pattern of access of the plurality of files accessible via the network.

16. The method of claim 15, wherein the triggering event associated with the file is at least one of creating the file, opening the file, saving the file, or accessing the file for a predetermined time.

17. The method of claim 15, wherein the data associated with the electronic device acting on the file is based at least in part on a predetermined data set operable to identify an electronic device.

18. The method of claim 17, further comprising:
modifying the predetermined data set based at least in part on the pattern of access of the plurality of files accessible via the network.

19. The method of claim 15, wherein the data associated with the file and the electronic device is at least temporarily stored on the electronic device prior to the data being sent to the host device.

20. A system, comprising:
an electronic device in communication with a network, the electronic device configured to act on a file accessible via the network;
a beacon agent in communication with the network, the beacon agent configured to collect data associated with the file and the electronic device in response to a triggering event; and
a host device in communication with the network, the host device coupled to a database configured to store data associated with a plurality of files accessible via the network and a plurality of electronic devices having acted on at least one file from the plurality of files, the host device configured to:
receive (1) a request for a uniform resource identifier (URI) of a resource stored on the network and (2) the data associated with the file and the electronic device collected by the beacon agent,
store the data associated with the file and the electronic device in the database,
analyze the data stored in the database associated with the plurality of files and the plurality of electronic devices to define an analyzed data set, and
define a pattern of access of the plurality of files accessible via the network.

21. The system of claim 20, wherein the beacon agent is executed on the electronic device.

22. The system of claim 20, wherein the beacon agent is executed on the host device.

23. The system of claim 20, wherein the beacon agent is configured to insert a beacon in the file.

24. The system of claim 23, wherein the beacon includes at least the URI of the resource.

25. The system of claim 20, wherein the host device is configured to receive a signal including the request for the URI and the data associated with the file and the electronic device, the signal being received via a predetermined modality.

26. The system of claim 25, wherein the predetermined modality is Internet Protocol version 6 (IPv6) such that the signal is configured to bypass at least one of virtual private network (VPN) obfuscation or firewall restrictions.

27. The system of claim 25, wherein the predetermined modality is Sever Message Block (SMB).

28. The system of claim 27, wherein the predetermined modality is Common Internet File System.
